(19) United States
(12) Patent Application Publication
(10) Pub. No.: US 2025/0124066 A1
(43) Pub. Date: Apr. 17, 2025

(54) RETRIEVAL-AUGMENTED CONTENT GENERATION FOR LEGAL RESEARCH

(71) Applicant: Thomson Reuters Enterprise Centre GmbH, Zug (CH)

(72) Inventor: Gayle McElvain, Arlington, VA (US)

(21) Appl. No.: 18/917,941

(22) Filed: Oct. 16, 2024

Related U.S. Application Data
(60) Provisional application No. 63/544,366, filed on Oct. 16, 2023.

(51) Int. Cl. G06F 16/335; G06F 16/338

(52) U.S. Cl. CPC G06F 16/335; G06F 16/338

(57) ABSTRACT

Embodiments support systems and methods for large language model (LLM)-assisted research tools that support retrieval-augmented content generation. In an aspect, the disclosed systems and methods may provide functionality for receiving, by one or more processors, a set of search criteria via a graphical user interface. The systems and methods may also include functionality for providing, by the one or more processors, the set of search criteria or information derived from the set of search criteria as one or more prompts to one or more LLMs, and for generating, by the one or more LLMs, textual content based on the one or more prompts. The textual content may include information associated with one or more legal issues associated with the set of search criteria.

### CROSS-REFERENCE TO RELATED APPLICATIONS

The present application claims the benefit of priority from U.S. Provisional Application No. 63/544,366 filed Oct. 16, 2023 and entitled “RETRIEVAL-AUGMENTED CONTENT GENERATION FOR LEGAL RESEARCH,” the disclosure of which is incorporated by reference herein in its entirety.

### TECHNICAL FIELD

The present subject matter is directed generally to research systems and more particularly, to legal research systems supporting artificial intelligence (AI)-assisted research synthesis and analysis and retrieval-augmented content generation.

### BACKGROUND OF THE INVENTION

There are many legal research systems presently available for conducting legal research. Such systems typically have a user input keywords and phrases that should be utilized to query one or more legal research databases to identify legal research relevant to the input keywords and phrases. As an example, a user may type in several keywords or phrases and receive back a set of legal documents (e.g., case law documents, journal articles, treatises, statutes, etc.) containing information responsive to the input. That is to say, existing legal research systems are designed to merely identify legal documents containing information included in or relevant to the input keywords and phrases but are not able to synthesize data in response to the search inputs. Additionally, users may have difficulty identifying the correct keywords and terms to provide as input to obtain satisfactory search results. The user may also need to format the keywords and inputs using a specific format or syntax (e.g., to combine search terms using AND, OR, and the like), which may be challenging for some users and may limit the quality of the search results obtained.

Traditional search engines excel at efficient methods for keyword and concept match within large document collections, but they are limited in their ability to interpret user intent. This is particularly evident in vertical domains where the concentration of users seeking similar information is dramatically less than an ad-hoc web search. Since there is less signal from users about which documents are relevant to a given query, these systems rely considerably more on linguistic interpretation and the integration of domain-specific relevance signals.

As an information retrieval task, legal research requires both high precision and high recall. Precision is needed because the corpus is vast and highly redundant, such that it can be extremely time-consuming to review all the potentially relevant sources of information. Recall is important because an instance of missing material information can have expensive real-world consequences in many professional settings. When the corpus is large and there are many ways of characterizing similar information, traditional approaches will miss relevant documents due to language variability, unless the user is painstakingly precise in formulating their query. At the same time, many documents with high term overlap will not match the full intent of a query, which makes document review time consuming and tedious.

### BRIEF SUMMARY OF THE INVENTION

Embodiments of the present disclosure provide systems, methods, and computer-readable storage media supporting AI-assisted research synthesis and analysis and retrieval-augmented content generation. The AI-assisted research synthesis and analysis techniques described herein may be configured to support generation of natural language textual content responsive to inputs provided by researchers, as well as enable analysis of natural language content. For example, a researcher interested in one or more legal issues may present a prompt to a research tool configured in accordance with the concepts disclosed herein. Responsive to the prompt, the research tool may utilize AI and large language model (LLM)-based techniques to generate and analyze information identified based on the prompt and summarize all or portions of the information. To prevent hallucinations or other inaccuracies by the LLM, the disclosed techniques may provide one or more legal documents (e.g., case law documents, metadata, statutes, regulations, journal articles, and the like) identified based on inputs for analysis and the LLM may generate the natural language text content based on the one or more legal documents, thereby providing retrieval-augmented natural language content generation. In an aspect, the AI-assisted research tools may be configured to support a dialogue in which the researcher may input a set of search criteria, which may take the form of one or more natural language text inputs written in conversational language, rather than a series of keywords, phrases, and syntax designations (e.g., AND, OR, etc.). An initial response to the researcher's input may be generated and the researcher may provide additional inputs to refine the responses output by the AI-assisted research tools.

In an aspect, a method for performing AI-assisted research in accordance with aspects of the present application is disclosed and includes receiving, by one or more processors, input specifying a set of search criteria using natural language text. The method also includes executing, by the one or more processors, one or more searches based on the set of search criteria specified in the input. The one or more searches may involve a search of at least one data source, such as a data source containing legal documents. The method includes obtaining, by the one or more processors, an initial set of search results based on the one or more searches. The initial set of search results may include search results corresponding to different result types (e.g., case law documents, statutes, regulations, journal articles, and the like). In an aspect, the method may restrict a number of search results included in the initial set of search results for each of the different result types. In an aspect, at least a portion of the initial set of search results may be identified based on outputs of a clustering algorithm.

The method also includes providing, by the one or more processors, a prompt to an LLM. The prompt may include information associated with the initial set of search results, the set of search criteria, or both. The prompt may include the input and portions of the initial set of search results identified as being relevant to the set of search criteria. The method also includes outputting, by the one or more processors, a response to the input based on content generated by the large language model. The response may be generated by the LLM based on the prompt. In an aspect, the response may be generated via an iterative process. For example, during each iteration of the iterative process, a portion of the initial set of search results may be presented to the LLM and an interim response may be generated. The interim response and a next portion of the initial set of search results may then be provided as input to a next iteration of the iterative process until the response is output. In an aspect, the method includes evaluating an accuracy of the response to the set of search criteria and may also include enhancing the response based at least in part on the evaluating. Enhancing the response may include determining one or more authorities to cite in the response, detecting negative treatment of one or more results included in the initial set of search results, altering a format of the response, incorporating treatment information into the response, or a combination thereof.

The method may also include outputting a question to the user. The question may be configured to obtain additional information related to the set of search criteria. In an aspect, the response may be updated based on additional information received in response to the question. In an aspect, the method includes identifying portions of each search results in the initial set of search results relevant to the set of search criteria. In an aspect, the method may include ranking or reranking each portion of the initial set of search results identified as relevant to the set of search criteria.

In an aspect, the method may include analyzing the input to determine a suitability of the input for LLM content generation and prompting the user for additional information based on the analyzing. In an aspect, the response includes a summary of one or more search results included in the initial set of search results. The summary may include information associated with negative treatment of at least one search result of the initial set of search results, information associated with fact patterns for at least one search result of the initial set of search results, information summarizing a portion of the initial set of search results, suggestions to expand a search based on the inputs, or a combination thereof. In an aspect, the method includes training the LLM. For example, the training may be configured to train the LLM to summarize content, interpret or analyze content, or both.

In an additional or alternative aspect, a method is disclosed and includes receiving, by one or more processors, a set of search criteria via a graphical user interface. The method also includes providing, by the one or more processors, the set of search criteria or information derived from the set of search criteria as prompt to an LLM. The method also includes generating, by the LLM, textual content based on the prompt. The textual content may include information associated with one or more legal issues associated with the set of search criteria.

According to aspects of the disclosure, the method may include ranking, by the one or more processors, a subset of headnotes, based at least in part on the set of classifications and the set of headnote scores to produce a ranked set of headnotes, wherein the ranked set of headnotes is configured to quantify a relevance of each headnote of the subset of headnotes to the query, wherein a first headnote score corresponding to a first headnote of the subset of headnotes is based on information associated with a first portion of the first headnote and wherein a ranking of the first headnote is based on information associated with a second portion of the first headnote, and wherein the information associated with the first portion of the first headnote is different from the information associated with the second portion of the first headnote.

In an aspect, the method may include outputting, by the one or more processors, a highest ranked headnote (e.g., an optimized headnote) based on the ranked set of headnotes.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a block diagram of a system providing functionality to support artificial intelligence (AI)-assisted research and analysis in accordance with aspects of the present disclosure.

FIG. 2 is a block diagram of an example LLM engine in accordance with aspects of the present disclosure.

FIG. 3 is a block diagram of an example workflow for performing a search in accordance with aspects of the present disclosure.

FIG. 4 is a flow diagram of an example method for performing a search in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE INVENTION

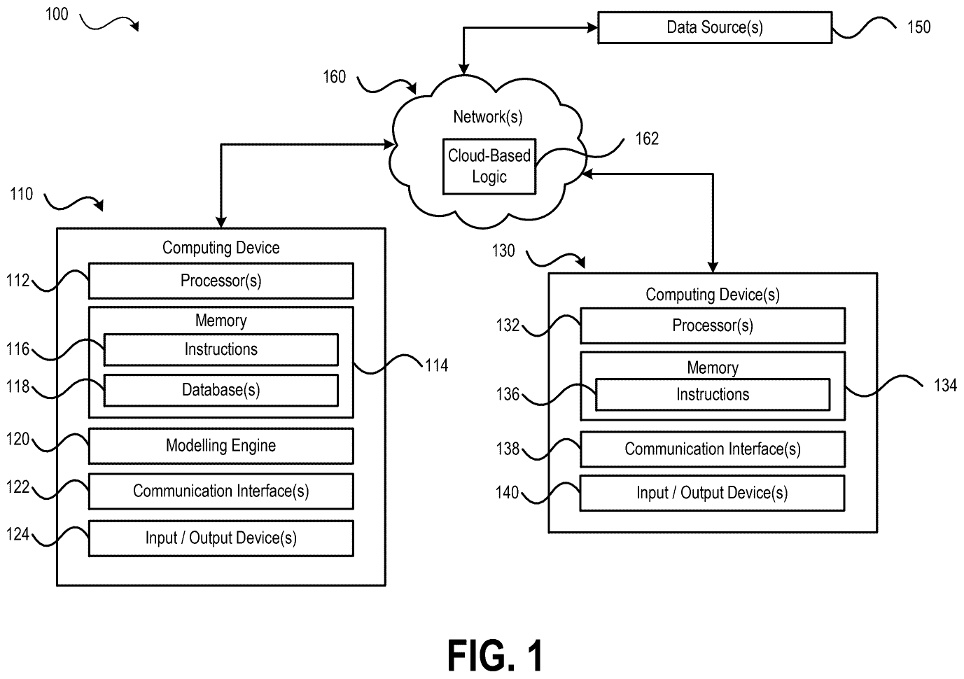

Referring to FIG. 1, a block diagram of a system providing functionality to support AI-assisted research and analysis in accordance with aspects of the present disclosure is shown as a system 100. The system 100 may be configured to support retrieval-augmented content generation for legal research or other research domains. The system 100 may be configured to receive inputs corresponding to a legal issue or question from a researcher device 130. In contrast to prior legal research systems, in which researcher inputs were more commonly submitted as a query (e.g., a set of keywords, phrases, and syntax information), the system 100 supports conversational research inputs and may also support an interactive or dialogue-style searches, rather than simply outputting search results as a list of documents. Exemplary details for providing LLM-assisted research in accordance with the concepts disclosed herein are described in more detail below and in the attached Appendices.

As illustrated in FIG. 1, the system 100 includes a computing device 110 that includes one or more processors 112, a memory 114, an LLM engine 120, one or more communication interfaces 122, and input/output (I/O) devices 124. It is noted that while FIG. 1 illustrates computing device 110 as a standalone or physical device (e.g., a desktop computing device, a laptop computing device, a server, etc.), it is to be understood that the functionality provided by the computing device 110 may be implemented in distributed implementations via one or more computing devices 110 or as a cloud-based service, shown in FIG. 1 as cloud-based logic 162. The one or more processors 112 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 114 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may also store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 122 may be configured to communicatively couple the computing device 110 to the one or more networks 160 via wired and/or wireless communication links according to one or more communication protocols or standards. The I/O devices 124 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

The one or more databases 118 may be configured to store information and/or documents. For example, the one or more databases 118 may include one or more databases storing case law documents, regulations, statutes, journal articles, news articles, treatises, headnotes, other types of legal information, and/or non-legal information (e.g., sports information, etc.). Additionally, or alternatively, the information described above as being stored in the one or more databases 118 may be stored at one or more external data sources, such as a data source 140, as shown in FIG. 1.

The functionality provided by the computing device 110, and more specifically the LLM engine 120, may be configured to support LLM-assisted research tools in accordance with the concepts described herein and in the attached appendices. For example, a researcher may be associated with a computing device 130 having one or more processors 132, a memory 134, one or more communication interfaces 138, and one or more I/O devices. The one or more processors 132 may the same as the one or more processors 112; the memory 134 may the same as the memory 114; the memory 134 may the same as the memory 114; and the one or more communication interfaces 138 and the one or more I/O devices 140 may the same as the one or more communication interfaces 122 and the one or more I/O devices 124. The memory 134 may store instructions 136 that, when executed by the one or more processors 132, cause the one or more processors 132 to perform operations described with reference to the computing device 130, as described herein.

As an illustrative example, via the computing device 130, the researcher may access the computing device 110 to perform research on one or more legal issues or topics. The research process may include providing inputs (e.g., via the one or more I/O devices 140) to the computing device 130, which may be transmitted to the computing device 110 over the one or more networks 160. In an aspect, the inputs may specify search criteria in the form of conversational or natural language text, such as to input “Can federal courts exercise jurisdiction over claims by non-residents who opt-in to collective actions under flsa?” In contrast to prior research systems, where researcher inputs were typically provided in the form of keywords and syntax identifiers, using conversational inputs like the non-limiting example above may be more natural to a researcher. Notably, the types of inputs the LLM engine 120 is designed to receive and utilize for performing searches may not be usable by traditional search engines that are configured to receive only keywords. For example, a natural language text input may create many extraneous or irrelevant search results if provided to traditional search engines, which may result in a poor experience and make performing research more difficult for the researcher (e.g., because manual effort may be required for the researcher to identify relevant search results).

The LLM engine 120 may execute one or more searches based on the set of search criteria specified in the input. For example, the one or more searches may involve a search of at least one data source, such as a data source containing legal documents (e.g., the one or more database 118 the one or more data sources 140, or both). In an aspect the LLM engine 120 may perform one or more pre-processing operations on the input to generate a query that may be used to perform the one or more searches, as explained in more detail below. The LLM engine 120 may perform one or more searches based on the query generated from the inputs to obtain an initial set of search results. The initial set of search results may include search results corresponding to different result types (e.g., case law documents, statutes, regulations, journal articles, and the like). In an aspect, the LLM engine 120 may be configured to restrict a number of search results included in the initial set of search results for each of the different result types. In an aspect, at least a portion of the initial set of search results may be identified based on outputs of a clustering algorithm.

The LLM engine 120 may also receive or generate a prompt, which may be presented as input to an LLM of the LLM engine 120. The prompt may include information associated with the initial set of search results, the set of search criteria, or both. The prompt may include the input and portions of the initial set of search results identified as being relevant to the set of search criteria. The LLM engine 120 may output a response to the input based on content generated using the LLM of the LLM engine 120. The response may be generated using the LLM based on the prompt. In an aspect, the response may be generated via an iterative process. For example, during each iteration of the iterative process, a portion of the initial set of search results may be presented to the LLM and an interim response may be generated. The interim response and a next portion of the initial set of search results may then be provided as input to a next iteration of the iterative process until the response is output.

In an aspect, the LLM engine 120 may be configured to evaluate an accuracy of the response to the set of search criteria and may enhance the response based at least in part on the evaluating. For example, enhancing the response may include determining one or more authorities to cite in the response, detecting negative treatment of one or more results included in the initial set of search results, altering a format of the response, incorporating treatment information into the response, or a combination thereof.

The computing device 110 may also provide functionality designed to prevent or reduce the likelihood of hallucinations or other inaccuracies being present in the outputs of the LLM engine 120. It is noted that in the context of LLMs the term “hallucinations” is not well-defined. In the context of the present disclosure the term “hallucination” refers to mis-citing misattribution of information included in the output of the LLM of the LLM engine 120. For example, if the LLM of the LLM engine 120 generates content based on a source of law, the hallucination mitigation functionality of the LLM engine 120 may be configured to verify the piece of information came from a search result. In an aspect, the LLM engine 120 may be configured to not only verify the content came from one of the search results, but also the context of the subject matter within the search result(s). For example, the LLM may: (1) select the wrong document identifier (e.g., identify the wrong search result based on context in the prompt); (2) reproduce a valid characterization of the input, but it just assigned the wrong document title (e.g., associated the characterization with the incorrect search result); (3) mischaracterize what was actually stated in the document (e.g., the summarized information may correctly identify where the information came from, but may not have the same meaning as what the summary says); or (4) cite to the correct case and the summary content may be correct (e.g., correct language or meaning), but the content was taken from a section of the case that is not a holding (e.g., is not precedential), such as a discussion of background information or an argument from one party. Further details on the above-described functionality are described below.

The LLM engine 120 may also be configured to provide a search refinement process to improve the inputs used to perform the search. The search refinement process may include outputting a question to the researcher. For example, the question may be presented to the researcher in order to obtain additional information related to the set of search criteria previously received from the researcher, such as to determine whether a search of legal documents should be limited to a particular jurisdiction (e.g., federal court, a specific state court or circuit court, etc.) or the search is intended to be jurisdiction agnostic (e.g., if no specific jurisdiction(s) are provided in response to the question). It is noted that presenting a question related to jurisdiction of a search has been provided as a non-limiting example and other types of questions may be presented to the researcher via the search refinement process in accordance with the concepts described herein. In an aspect, the response may be updated based on additional information received in response to the question. In an aspect, the LLM engine 120 may identify portions of each search results in the initial set of search results relevant to the set of search criteria, including any additional search criteria obtained from the search refinement process described above. In an aspect, the LLM engine 120 may rank or re-rank each portion of the initial set of search results identified as relevant to the set of search criteria and any additional criteria obtained via the search refinement process.

In an aspect, the LLM engine 120 may analyze the input to determine a suitability of the input for LLM content generation and may prompt the researcher for additional information based on the analyzing. In an aspect, the response may include a summary of one or more search results included in the initial set of search results. The summary may include information associated with negative treatment of at least one search result of the initial set of search results, information associated with fact patterns for at least one search result of the initial set of search results, information summarizing a portion of the initial set of search results, suggestions to expand a search based on the inputs, or a combination thereof. In an aspect, the LLM engine 120 provides functionality that supports training one or more LLMs. For example, the training may be configured to train the LLM to summarize content, interpret or analyze content, or both.

In an additional or alternative aspect, the LLM engine 120 may receive a set of search criteria via a graphical user interface, provide the set of search criteria or information derived from the set of search criteria (e.g., search results or portions of search results, context information extracted from the search criteria, etc.) as prompt to an LLM. The LLM may generate textual content based on the prompt. The textual content may include information associated with one or more legal issues associated with the set of search criteria. For example, the user may provide a natural language text input to the LLM engine 120. The natural language text input may be used to perform a search of one or more data sources 150 (e.g., legal document databases containing case law documents, statutes, treatises, journal articles, and the like). The search may return a set of legal documents believed to be relevant to the input text. A prompt may be generated based on the search criteria (e.g., natural language text) and at least a portion of the set of legal documents returned from the search. The prompt may be provided to the LLM of the LLM engine 120 to generate text content, where the generated text content may include a summary or other information contained in the portion of the set of legal documents. In an aspect, one or more links may be incorporated into the generated content. For example, a link may be incorporated into the generated content in association with a sentence or paragraph of the generated content and provide a hyperlink to one or more of the legal documents where a source for the generated content may be found and verified.

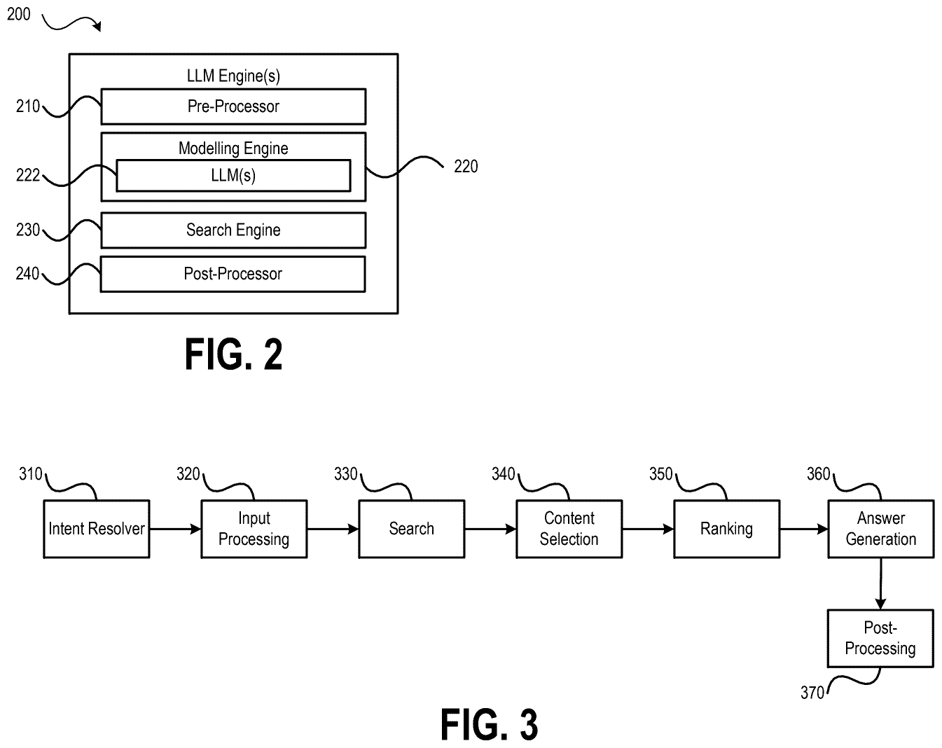

Having generally described the functionality of the LLM engine 120 of the computing device 110 above, a more detailed description of the functionality provided by the LLM engine 120 will now be described with reference to FIGS. 2 and 3, which are block diagrams of an example LLM engine and process for performing a search in accordance with the concepts described herein, respectively. In FIG. 2, the LLM engine is shown as LLM engine 200, which may be the LLM 120 of FIG. 1. The LLM engine 200 includes a pre-processor 210, a modeling engine 220, a search engine 230, and a post-processor 240. The modeling engine 220 may include one or more LLMs 222. In an aspect, the one or more LLMs 222 may include a single LLM. In an additional or alternative aspect, the one or more LLMs 222 may include multiple LLMs, where different LLMs may be used to perform different tasks or generate different types of content. As a non-limiting example, a first LLM may be configured to generate content (e.g., a summary) based on search results obtained via a search performed using the search engine 230, while a second LLM may be used to generate feedback to the researcher, such as during the above-described search refinement process. It is noted that more LLMs may be utilized in some embodiments and that some of the multiple LLMs may be used to perform similar or the same tasks, such as to have multiple LLMs for generating content, where different ones of the LLMs may be more suited to generate content for different types of search results (e.g., a first LLM may be well-suited to summarize case law documents and a second LLM may be well-suited to summarize treatises or other types of legal or other documents obtained in a search) or for generating different types of content (e.g., one or more LLMs may be used to generate summaries of content and other LLMs may be used to generate links to content). In some implementations, an LLM may be provided to combine content generated by other LLMs and produce a final output of the LLM engine 200. For example, multiple LLMs may be used to summarize different types of search results and then a final LLM may receive the summaries from each upstream LLM and output a final summary incorporating the content output by each of the different LLMs into a single summary.

The pre-processor 210 may be configured to receive and resolve inputs from a researcher (e.g., block 310 of the workflow of FIG. 3). As explained above, unlike traditional search engines that rely on keywords to perform searches, the inputs from the researcher received by the pre-processor 210 may be provided as natural language text. The pre-processor 210 may be configured to analyze the inputs to understand the intent of the search (i.e., determine what the researcher is searching for). For example, the pre-processor 210 may be configured to perform an intent resolution process to extract meaning from the natural language text inputs provided by the researcher, where the inputs correspond to search criteria specified by the researcher. In an aspect, the intent resolution process provided by the pre-processor 210 may extract meaning from the inputs provided by the researcher using one or more of the LLMs 222. For example, in-context learning is a method of prompting LLMs to perform novel or domain-specific tasks without updating learned model parameters. The pre-processor 210 may be configured to leverage in-context learning to generate an analysis of the inputs. In an aspect, the pre-processor 210 may be configured with LLMs fine-tuned for specific intent resolution tasks (e.g., tasks designed to extract the intent of the input received from the researcher). In an aspect, the analysis may include identifying: (1) the type of task for which the user is seeking assistance, (2) restrictions on the scope of potentially relevant materials, and (3) known concepts or entities. In an aspect, any or all of these identifiable features may be defined and identified within one or more legal taxonomies already embedded in a semi-structured knowledge base.

In an aspect, the pre-processor may be configured with one or more pre-determined prompts to extract the intent features from the inputs (e.g., by providing the inputs and one or more of the pre-determined prompts to the one or more LLMs 222), as shown at block 320 of the workflow of FIG. 3. For example, the pre-determined prompts may be developed by subject matter experts and may be designed to leverage tooling designed to optimize the process of evaluating the inputs using LLMs. Non-limiting examples of different intent features that may be extracted by the pre-processor 210 during intent resolution may include: (1) Task Intents: answer a complex legal question; find cases matching specific criteria; identify potential claims; summarize a document; draft an argument; compare jurisdictions; characterize citing references; provide a definition or blackletter statement of law; (2) Content Filters: jurisdiction; document type; court level; date range; judge; civil vs criminal substantive vs procedural; and (3) Related Concepts: cause of action; narrow legal issue; West Key Number topical classification; motion or outcome type. In an aspect, the outcome of the intent resolution process may determine one or more behaviors of downstream components or processes, including query generation, retrieval, and response generation. The pre-processor 210 may also determine whether the input is insufficient or otherwise inappropriate and return an informative response to the user (e.g., as explained above with reference to the search refinement process). In an aspect, one or more types of searches may be associated with intents that are not intended to be processed by the LLM engine 200. For example, there may be particular searches or questions that the LLM engine 200 may be prohibited from answering. Non-limiting examples of query generation include reformulation for underspecified requests, closed book answer generation to overcome vocabulary mismatch, and task/question decomposition for multi-intent requests. Large language models may be fine-tuned to better recognize domain-specific intents.

As part of the input processing performed at block 320 of FIG. 3, the pre-processor 210 may also be configured to use the output from the intent resolution and other input processes to determine one or more search strategies for querying one or more data sources (e.g., the one or more data sources 150 of FIG. 1) for content responsive to the inputs and the researcher's intent (e.g., as determined by the intent resolution process). Depending on the type of intent, the pre-processor may perform query expansion (e.g., to generate a query configured to search for related concepts) or generate queries with precise fields (e.g., queries with a Boolean syntax, etc.). Like the intent resolution process described above, the query generation process performed by the pre-processor may include generation of text using LLMs and in-context learning.

The text generated by the LLMs after intent resolution is complete may be used as a query (e.g., at block 330 of the workflow of FIG. 3) to perform a search of the one or more data sources for a set of legal documents responsive to the inputs received from the researcher. In an aspect, the search performed using the query may be a federated search, where multiple data sources associated with different types of content (e.g., different types of legal documents and the like). Performing a federated search may improve the response time of the LLM engine 200 by making it possible to access and retrieve content from multiple data sources without needing to search each one separately. The federated search may also reduce power consumption and consume less computing resources as compared to performing individual searches of each data source separately. A federated search may also be provide the advantage of combining different perspectives for a given query.

The search performed based on the query may be configured to identify content that answers the researcher's question, identify content that may be used to rank, sort, or validate other search results (e.g., as possible examples beyond answering the researcher's question), other purposes, or a combination thereof. It is noted that for complex legal questions it may be particularly important to consider a diversity of sources during the search for potentially relevant information. In an aspect, the search engine 230 may leverage multiple indexing and retrieval strategies to perform a federated search of disparate collections of content (e.g., different ones of the data sources 150 of FIG. 1) in parallel and increase the diversity of relevant results. The search engine 230 may use one or more of the following dimensions to determine the breadth and diversity of results:

(1) Source selection may be used to determine what types of documents to include in discovery. For a legal search, the searched data sources may include one or more databases containing primary law (e.g., judicial opinions, statutes, regulations, administrative guidance), briefs and other documents filed in litigation, and secondary sources (e.g., treatises, legal encyclopedias and other commentary publications). As explained above, the researcher may indicate which sources they want to search. In an aspect, all available sources may be considered during the search (e.g., by default), and the search engine may attempt to select the most appropriate data sources for locating content responsive to the researcher's input. In an aspect, the intent resolver may also be used to inform content selection, such as to extract intent or context information from the search results that may be used to select content and/or rank content included in the search results.

(2) Indexing strategy may be used to determine how the selected data sources are searched. For example, multiple indexes may be created for each document collection (e.g., each data source). Passage and document level indexes may also be created. Auxiliary indexes may be leveraged for certain document types (e.g., document types with substantial editorial enhancements). Case law, for example, has auxiliary indexes for editorially created headnotes, and, synopses. All of the passage level content may be embedded by language models adapted for the legal domain. The embeddings may be indexed for dense retrieval via approximate nearest neighbor (ANN) search. At run time, queries are embedded with the same language model(s) used for the index to execute the search. In an aspect, the embeddings of content maintained at a data source may and the embeddings for the input from the researcher may be determined to be relevant to each other based on how similar the embeddings of an item of content in a data source is to the embeddings of the input (e.g., content closely related to the question presented in the input may be closer as determined using the nearest neighbors algorithm to content less relevant to the question).

(3) Query expansion, which is a process of executing multiple queries based on the interpretation of researcher input, may also be used by the search engine 230. It is noted that not all user requests require query expansion, but it may improve recall for complex questions. As used herein, query expansion may include embedding the same query using multiple models. The different embeddings produced by each model may be used to search different data sources (e.g., each query embedding may be generated based on a form used to generate embeddings for each data source). In an aspect, the different query embeddings may also be used by an LLM to generate multiple reformulations of the query or researcher input.

After executing a search or federated search over one or more data sources (e.g., with one or multiple queries based on utilization of query expansion) using the search engine 230, the post-processor may be configured to perform a content selection process (e.g., at block 340 of FIG. 3) in which passages are selected from documents in the search result set. It is noted that the search result set may include zero or more documents or pieces of content identified as relevant to the researcher inputs from among the searched data source(s). In an aspect, a relevance model may be applied by the post-processor 240 to identify passages from each search result. The selected passages from one or more documents may be merged into a candidate pool and associated with metadata from the source documents. For example, the metadata may identify which document each passage came from, a location in the document where the passage is found (e.g., a paragraph number, page and line numbers, or other information identifying the passage), and other information. In an aspect, the candidate pool may correspond to the search results but may have duplicate search results removed. In an aspect, a hydration algorithm may be utilized to annotate or associate each search result with relevant attributes that may be used when prompting an LLM during synthesis of or generation of content based on the search results set. For example, the attributes may include descriptions of negative treatment flags associated with one or more search results, case synopses, court level (e.g., district court, circuit court, Supreme Court, etc.), and filing date. Such annotations may be used when prompting an LLM for synthesis of the relevant evidence, such as when the LLM is used to summarize the search results in a manner that is responsive to the inputs received from the researcher, as described in more detail below.

The post-processor 240 may also be configured to provide relevance scoring and ranking functionality (e.g., at block 350 of FIG. 3) to support generation of content based on the search results obtained by the search engine 230 based on the inputs from the researcher. The relevance and scoring functionality may be invoked by the post-processor 240 after the search results from all data sources have been merged into a single candidate pool. However, at this point the results from different queries may not have been combined into a single list ranked by evidence (e.g., ranked as relevant to the inputs from the researcher based on contents of each search result). To effectively fuse search results from different query strategies, the post-processor 240 may apply a set of passage level relevance models to passages in the candidate pool (i.e., the search results). The relevance models employed at this stage are trained to predict a likelihood of a sentence or paragraph being highly relevant to the query or question presented by the inputs from the researcher. In an aspect, the relevance models are trained on different types of relevance judgments. For example, the relevance judgments may include manual annotation by trained subject matter experts and derived signals approximating human judgment. The relevance models may be more computationally expensive than embedding models employed for dense retrieval (e.g., passage level relevance). To avoid the higher computational cost and complexity, a cross-encoder architecture, transformer-based LLM, and the like may be leveraged for determination of the passage level relevance. As a non-limiting example, a cross-encoder may be provided that outputs a score based on how relevant a particular passage of a search result is to the intent of the input received from the researcher (e.g., does the passage contain content relevant to answering the researcher's question).

The relevance models may be used to assign a score to each passage, each sentence, or both to produce a set of ranked set of passages and/or sentences. Once all the passages and/or sentences have been assigned a relevance score, the scores may be aggregated to produce a document level score indicating an overall semantic relevance of the corresponding document to the researcher input. In an aspect, the aggregation function may be learned from manually labeled examples. In an additional or alternative example, the aggregation function may be a weighted average over all the scored portions of a document. As a non-limiting example, a suitable function for rank aggregation may be the reciprocal rank fusion (RRF), which can be applied directly over a set of passage embeddings to produce a vectorized version of RRF that combines passage representations before ranking. Relevance scores, rather than ranks, may also be fused via this approach if the underlying relevance model produces meaningful scores across passage types. In some configurations, the candidate pool may be expanded to consider additional sources, such as citing and cited references, if they are indicated as relevant search results.

The post-processor 240 may also be configured to incorporate signals about the authority or credibility of each source together with the semantic relevance of information provided by that source during ranking. Semantic relevance scores may be adjusted to account for factors such as citation frequency, document age, and court level. For example, it may not be uncommon for many primary law materials to provide the same or highly similar information for a given query. When there are many sources with similar semantic relevance, the most authoritative sources are chosen to maximize utility for the legal research workflow. Based on the rankings, a final set of sources and scored or selected passages may be obtained, which may be used for response generation (e.g., to generate a response to the inputs received from the researcher).

During response generation (e.g., at block 360 of FIG. 3), the post-processor 240 may combine highly relevant passages with document level metadata and task instructions to create a prompt that may be provided as input to an LLM for sequence generation. The input provided to the LLM may include a representation of at least a portion the search results, such as relevant passages of one or more search results. The relevant passages may be selected based on the ranking information (e.g., the final set of sources and scored passages determined based on the relevance and ranking process). In an aspect, the passages, document level metadata, and task instructions may be concatenated and tokenized to produce an input vector that is provided to the LLM as input. It is noted that by selecting the relevant passages based on the ranking information the portions of the search results provided to the LLM may contain the information most likely to provide useful information for responding to the inputs from the researcher.

In an aspect, response generation may proceed one token at a time by sampling from a conditional probability distribution over the token vocabulary. In an aspect, multiple prompts may be used based on the task intent and the amount of relevant information to synthesize into a coherent response. For example, if there is a lot of evidence, passages may be grouped by document and organized into “pages” of search results, or the context for answer generation may be organized by jurisdiction, co-occurring citations, or sub-issue. The LLM may then be used to generate a complete response based on the first page and then may revise the response based on each subsequent page as necessary. In some configurations, an LLM may be used to generate and revise an answer multiple times. It is noted that dividing the inputs to the LLM into pages may be less efficient (e.g., both computationally and from a resource utilization perspective) as compared to more intelligently using the rankings to select the most relevant portions of the search results and using one or more intelligently engineered prompts to generate the response in a single pass (e.g., rather than performing multiple iterations over pages of search results content). In an aspect, the post-processor 240 may apply text classifiers and validation rules to control the generation process and determine when to stop (e.g., for page-based response generation). In an aspect, a structure of the response generated by the LLM may be templated by the LLM based on task intent. For example, when the task intent is a complex legal question, the response may contain a high-level summary followed by more detailed analysis of the supporting materials covering different aspects of the question.

In an aspect, the post-processor 240 may be configured to perform additional processing following response generation (e.g., at block 370 of FIG. 3). For example, the post-processor may perform verification of the response output by the LLM. For example, the prompt instructions combined with relevant evidence from the search results may be used to condition the LLM to copy its input as closely as possible from the source documents (e.g., the ranked search results), while generating a conversationally fluent response. Such constraints may avoid introducing information from outside the input. This may be achieved by conditioning the model to align input and output sequences. As a non-limiting example, the prompt to the LLM may include highly detailed and redundant instructions for inserting inline cites into the output text, which forces the LLM to carefully attend to the source materials with each output token, since it requires generating one or more passage identifiers (IDs) to support each substantive point in the response. In an aspect, the data validation rules may be applied by the post-processor 240 before presenting the response to the researcher.

Due to the nature of generative LLMs, the output may not be entirely constrained by limiting instructions in the prompt used for response generation. Accordingly, while prompt engineering may provide an effective method of introducing soft constraints, hard constraints and additional processing may be used as a further measure to control the content output by the LLM. For example, the post-processor 240 may independently check whether any hard constraints have been violated during generation and determine if a revised response is needed. Depending on the specific violation, the post-processor 240 may either generate a new response from the original input or pass the current response with new instructions to generate a revised response. This step may be applied multiple times, though it is generally only necessary to perform once.

As another example of operations performed at block 370 of FIG. 3, the answer may be submitted to an attribution process for incorporation of attribution of supporting materials. Verifying the accuracy of information in generated responses may be an important step for researchers, who need to trust the content of the response is fully supported by the underlying documents represented in the search results. To encourage and simplify this task, the post-processor 240 may perform an independent alignment of each input source against each sentence of generated output. In an aspect, a token alignment algorithm may be utilized to align source and sentence content in the generated output. For example, the tokenized portions of the search results presented to the LLM during response generation and a tokenized representation of the response may be subjected to the token alignment algorithm. The token alignment algorithm may be configured to find sequences of tokens that are the same, which will indicate that a portion of the response corresponds to content from a particular source document. The document level metadata or other information may then be utilized to identify which source document the matched tokens likely came from and a source of the relevant portion of the response may be determined. In an aspect, if multiple potential sources are identified, a tie breaker algorithm may be applied. The tie-breaker algorithm may select the source document having the best alignment (e.g., most tokens aligned) or highest level of document authority (e.g., selecting a document from a higher court over a similarly aligned document from a lower court). It is noted that other tie-breaking algorithms may be utilized in accordance with the concepts described herein. In an aspect, the citations may be inserted as citations within the response and made visible to the user, such as when the user hovers a mouse pointer over the text corresponding to the citation. In an aspect, the citations may also hyperlinked to the source document to facilitate quick navigation directly to where language in response can be found in the underlying source document.

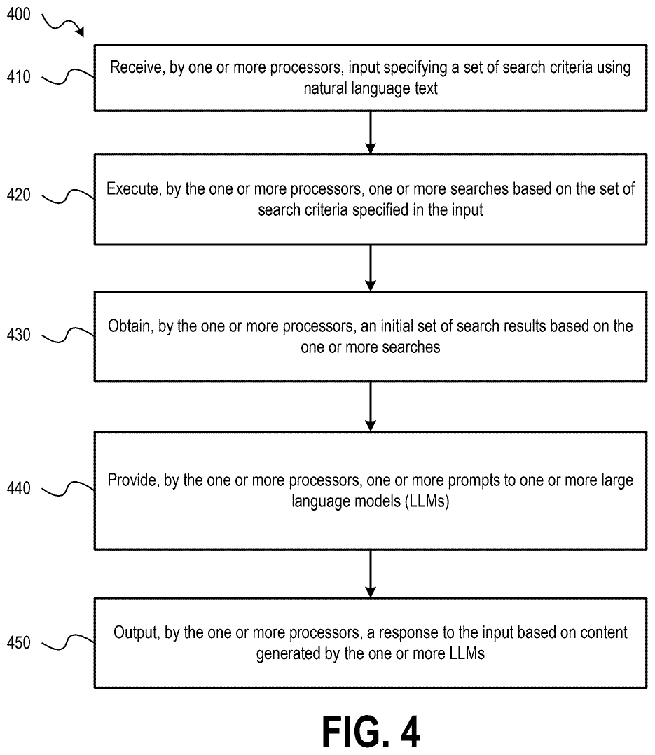

Referring to FIG. 4, a flow diagram of an example method for performing a search in accordance with aspects of the present disclosure is shown as a method 400. In an aspect, the method 400 may be stored as instructions (e.g., the instructions 116 of FIG. 1) that, when executed by one or more processors (e.g., the processors 112 of FIG. 1), cause the one or more processors to perform operations for performing a search in accordance with the concepts described herein based on natural language text inputs. In an aspect, the method 400 may be performed by a computing device (e.g., the computing device 110 of FIG. 1), an LLM engine (e.g., the LLM engine 120 of FIG. 1 or the LLM engine 200 of FIG. 2), or cloud-based logic (e.g., cloud-based logic 162 of FIG. 1).

At step 410, the method 400 includes receiving, by one or more processors, input specifying a set of search criteria using natural language text. As explained above, a search performed in accordance with aspects of the present disclosure may utilize natural language text, rather than keywords as used by traditional search engines. For example, the input(s) may include questions such as: (1) Are there any exceptions to law XYZ?; (3) Has the law on issue ABC changed?; (3) When does a particular legal procedure need to be done?; and the like. In an aspect, the received input may be subjected to one or more pre-processing operations, such as the pre-processing operations described above with reference to block 310 of FIG. 3.

At step 420, the method 400 includes executing, by the one or more processors, one or more searches based on the set of search criteria specified in the input. The one or more searches includes a search of at least one data source. In an aspect, step 420 of the method 400 may include operations associated with blocks 320, 330 of FIG. 3 described above. At step 430, the method 400 includes obtaining, by the one or more processors, an initial set of search results based on the one or more searches and at step 440, providing, by the one or more processors, one or more prompts to one or more large language models (LLMs). The initial set of search results comprise search results corresponding to different result types (e.g., case law documents, treatises, statutes, etc.). In an aspect, the method 400 may restrict a number of search results included in the initial set of search results for each of the different result types. For example, the initial set of search results may be restricted based on one or more rankings (e.g., passage rankings, document rankings, etc.). As explained above with reference to block 360 of FIG. 3, the prompt may include information associated with the initial set of search results, the set of search criteria, or both. In an aspect, the prompt may be generated based on a set of ranking metrics (e.g., as described above with reference to block 350 of FIG. 3) and the prompt may be engineered and generated as described above with reference to block 360 of FIG. 3. For example, portions of the initial set of search results having a threshold ranking (e.g., indicative of search results having content relevant to the answer to the question presented in the input received at step 410) may be incorporated into the prompt used to generate the prompt used to generate the response. As explained above with reference to FIGS. 2 and 3, the prompt may also be created using prompt engineering to constrain the LLM to generate the response based on the relevant portions of the initial set of search results, rather than based on knowledge within the general knowledge of the LLM, thereby reducing the likelihood that the response contains extraneous information not found in the search results.

At step 450, the method 400 includes outputting, by the one or more processors, a response to the input based on content generated by the LLM. As explained above, the response may be generated by the LLM based on the prompt and then subjected to one or more post-processing operations, such as the operations described above with reference to block 370 of FIG. 3. For example, the response may be evaluated to verify the content of the response against one or more passages of one or more documents obtained in the search at step 420 (e.g., to verify the response contains only information contained in the search results and/or from target portions of the search results, such as a holding in a case law document). As another example, the answer may be augmented with links to portions of the underlying documents where the content of the response may be found within one or more of the underlying documents. Other types of post-processing operations described herein may also be performed at step 450 prior to or after outputting the response.

As shown above, the method 400 and the operations associated with the LLM 200 of FIG. 2 and the workflow of FIG. 3 provide a new method of conducting searches for legal and other types of documents that is not dependent on use of keywords as search terms. Moreover, the method 400 provides for extraction of intent from the input search criteria (e.g., specified using natural language text) to inform the generation of a query to identify relevant search results across one or more data sources. The method 400 also provides for analysis of the search results to rank or quantify the relevance of each search result to the input received from the researcher, where the rankings information may be used to generate a prompt to an LLM that generates a response to the input received from the researcher in a human-readable and conversational form, rather than merely returning a list of the underlying documents identified in the search as in prior search engines used for legal and other types of research. Furthermore, the method 400 may incorporate processes to validate, verify, and augment the response generated by the LLM such that the researcher may have high confidence the response accurately portrays the contents of the search results and more particularly, portions of the search results responsive to the input provided by the researcher. Incorporation of links into the response further enables the researcher to quickly verify the response against the underlying documents, reducing the time required to review and verify which documents identified in the search are responsive to the input. Thus, the method 400 provides a process that improves search engine technology as compared to prior search engines that relied on keyword inputs to perform searches.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and Bin combination; A and C in combination; Band C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of what is specified, where the percentage includes 0.1, 1, 5, and 10 percent; and the term “approximately” may be substituted with “within 10 percent of’ what is specified. The phrase “and/or” means and or.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A method, comprising:
receiving, by one or more processors, input specifying a set of search criteria using natural language text;
executing, by the one or more processors, one or more searches based on the set of search criteria specified in the input, the one or more searches comprising a search of at least one data source;
obtaining, by the one or more processors, an initial set of search results based on the one or more searches;
providing, by the one or more processors, one or more prompts to one or more large language models (LLMs), wherein the one or more prompts comprise information associated with the initial set of search results, the set of search criteria, or both; and
outputting, by the one or more processors, a response to the input based on content generated by the one or more LLMs, wherein the response is generated by the one or more LLMs based on the prompt.

2. The method of claim 1, wherein the initial set of search results comprise search results corresponding to different result types.

3. The method of claim 2, further comprising restricting a number of search results included in the initial set of search results for each of the different result types.

4. The method of claim 1, wherein the one or more prompts comprises the input and portions of the initial set of search results identified as being relevant to the set of search criteria.

5. The method of claim 4, further comprising generating the response via an iterative process.

6. The method of claim 5, wherein, during each iteration of the iterative process, a portion of the initial set of search results is presented to the one or more LLMs and an interim response is generated, and wherein the interim response and a next portion of the initial set of search results are provided as input to a next iteration of the iterative process until the response is output.

7. The method of claim 1, further comprising outputting a question to the user, wherein the question is configured to obtain additional information related to the set of search criteria, and wherein the response is updated based on information received in response to the question.

8. The method of claim 1, further comprising identifying at least a portion of the initial set of search results based on outputs of a clustering algorithm.

9. The method of claim 1, further comprising identifying portions of each search result in the initial set of search results relevant to the set of search criteria.

10. The method of claim 9, further comprising ranking or re-ranking each portion of the initial set of search results identified as relevant to the set of search criteria.

11. The method of claim 1, further comprising evaluating an accuracy of the response to the set of search criteria.

12. The method of claim 11, further comprising enhancing the response based at least in part on the evaluating.

13. The method of claim 12, wherein enhancing the response comprises determining one or more authorities to cite in the response, detecting negative treatment of one or more results included in the initial set of search results, altering a format of the response, incorporating treatment information into the response, or a combination thereof.

14. The method of claim 1, further comprising analyzing the input to determine a suitability of the input for LLM content generation.

15. The method of claim 14, further comprising prompting the user for additional information based on the analyzing.

16. The method of claim 1, wherein the response comprises a summary of one or more search results included in the initial set of search results.

17. The method of claim 16, wherein the summary comprises information associated with negative treatment of at least one search result of the initial set of search results, information associated with fact patterns for at least one search result of the initial set of search results, information summarizing a portion of the initial set of search results, suggestions to expand a search based on the inputs, or a combination thereof.

18. The method of claim 1, further comprising training the one or more LLMs.

19. A method comprising:
receiving, by one or more processors, a set of search criteria via a graphical user interface;
providing, by the one or more processors, the set of search criteria or information derived from the set of search criteria as one or more prompts to one or more large language models (LLMs);
generating, by the one or more LLMs, textual content based on the one or more prompts, wherein the textual content comprises information associated with one or more legal issues associated with the set of search criteria.
